(19) United States
(12) Patent Application Publication
(10) Pub. No.: US 2023/0023662 A1
(43) Pub. Date: Jan. 26, 2023

(54) Chemical Sewer Pipe Liner System and Method

(71) Applicant: Motivo Group, Inc., Windsor, CO (US)

(72) Inventors: Darren Billings, Windsor, CO (US); Blake DeRango, Windsor, CO (US)

(21) Appl. No.: 17/869,540

(22) Filed: Jul. 20, 2022

Related U.S. Application Data
(60) Provisional application No. 63/225,624, filed on Jul. 26, 2021.

(51) Int. Cl. F16L 55/165; B29C 73/12; B29C 63/34; B29C 63/00

(52) U.S. Cl. CPC F16L 55/1654; B29C 73/12; B29C 63/34; B29C 63/0004; B29K 2309/08

(57) ABSTRACT

A method includes removing process waste from a pipe, performing at least one of inserting, pulling, and pushing a fiberglass liner that is impregnated with resin into position within the pipe, at least one of fusing and curing the fiberglass and resin liner in the pipe, and applying at least one coating of an application specific epoxy over a surface of the fiberglass and resin liner in the pipe.

### CROSS-REFERENCE TO RELATED APPLICATION

This application claims the benefit of U.S. Provisional Application No. 63/225,624 filed Jul. 26, 2021, entitled “Chemical Sewer Pipe Liner System and Method,” the entire contents of which are incorporated herein by reference.

### FIELD

This application relates generally to the trenchless repair of damaged hazardous material sewers. Applications covered include, but are not limited to, repairing and reinstatement of buried pipe beneath plant operating units, roadways, railways, and waterways.

### BACKGROUND

Traditional methods of repair and replacement of sewer pipes include top side excavation which in many cases is not feasible or very costly. Felt and fiberglass liners have been attempted in hazardous waste piping systems but they fail due to the nature of the materials being disposed of into the pipe.

It is with these issues in mind, among others, that various aspects of the disclosure were conceived.

### SUMMARY

According to one aspect, a chemical sewer pipe liner system and method is provided for providing a trenchless repair of a damaged pipe. In one example, the damaged pipe may be used to carry hazardous materials. The pipe liner system utilizes a tubular shaped fiberglass material that may be impregnated with resin and inserted into a process sewer line that has been cleaned. The fiberglass and resin may be pulled and/or pushed through the existing damaged pipe and positioned to repair specific damaged sections in the pipe.

In one example, a method may include removing process waste from a pipe, performing at least one of inserting, pulling, and pushing a fiberglass liner that is impregnated with resin into position within the pipe, at least one of fusing and curing the fiberglass and resin liner in the pipe, and applying at least one coating of an application specific epoxy over a surface of the fiberglass and resin liner in the pipe.

In another example, a system may include a fiberglass liner that is impregnated with resin and at least one of inserted, pulled, and pushed into position in a pipe that has process waste removed, an inflating device that inflates the fiberglass liner that is impregnated with resin to take a shape of the pipe, wherein the fiberglass and resin liner is inflated to 7.25 to 11.60 pounds per square inch, and a spin sprayer that applies at least one coating of an application specific epoxy over a surface of the fiberglass and resin liner in the pipe.

In another example, a system may include a fiberglass liner that is impregnated with resin and at least one of inserted, pulled, and pushed into position in a pipe to address identified structural imperfections in the pipe buried in the earth that has process waste removed, an inflating device that inflates the fiberglass liner that is impregnated with resin to conform to a shape of the pipe, wherein the fiberglass and resin liner is inflated to 7.25 to 11.60 pounds per square inch, and a spin sprayer that applies at least one coating of an application specific epoxy having a thickness of 0.20″ to 0.50″ over a surface of the fiberglass and resin liner in the pipe, the application specific epoxy withstanding at least one of hydrocarbons, benzene, hydrogen sulfide (H2S), and acids.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a diagram of a pipe liner system according to an example of the instant disclosure.

FIG. 2 is a cross-section view of the pipe liner system according to an example of the instant disclosure.

FIG. 3 is a photographic view of a component of the pipe liner system according to an example of the instant disclosure.

FIG. 4 is another photographic view of the component of the pipe liner system according to an example of the instant disclosure.

FIG. 5 is a flowchart of a method for installing the pipe liner system according to an example of the instant disclosure.

### DETAILED DESCRIPTION

The present disclosure is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present disclosure, as the disclosure encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms first, second, etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Aspects of a system and method for installing a chemical sewer pipe liner include a fiberglass liner that is impregnated with resin and at least one of inserted, pulled, and pushed into position in a pipe that has process waste removed, an inflating device that inflates the fiberglass liner that is impregnated with resin to take a shape of the pipe, wherein the fiberglass and resin liner is inflated to 7.25 to 11.60 pounds per square inch, and a spin sprayer that applies at least one coating of an application specific epoxy over a surface of the fiberglass and resin liner in the pipe.

The system and method for installing a chemical sewer pipe liner allow for the trenchless repair of damaged hazardous material sewers. This provides for the repair and reinstatement of buried pipe. The pipe is often buried beneath plant operating units, busy roadways, railways, and waterways. Conventional solutions of repair and replacement include top side excavation which in many cases is not feasible or can be very costly. These traditional solutions have attempted to utilize felt and fiberglass liners in hazardous waste piping systems but they fail due to the nature of the materials that are disposed into the pipe. They have been used by refineries and chemical plants but they fail because of the chemical products and hazardous materials in the pipe.

According to an example, a tubular shaped fiberglass material may be impregnated with resin and inserted into a process sewer line that has been previously cleaned. The fiberglass and resin may be pulled or pushed through the existing damaged pipe and positioned to repair the specific damaged sections.

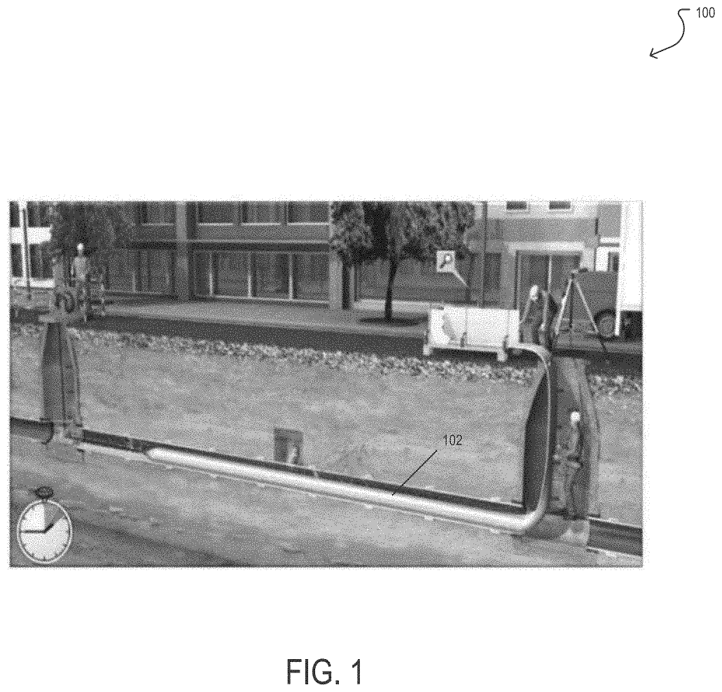

FIG. 1 illustrates a diagram of the pipe liner system 100 according to an example of the instant disclosure. As shown in FIG. 1, once the fiberglass and resin 102 is in position, it may be inflated to take the shape of the host pipe. Once the pipe is inflated, the curing and/or fusing may begin. As shown in FIG. 1, the repair of the pipe may be trenchless and can be accomplished above ground.

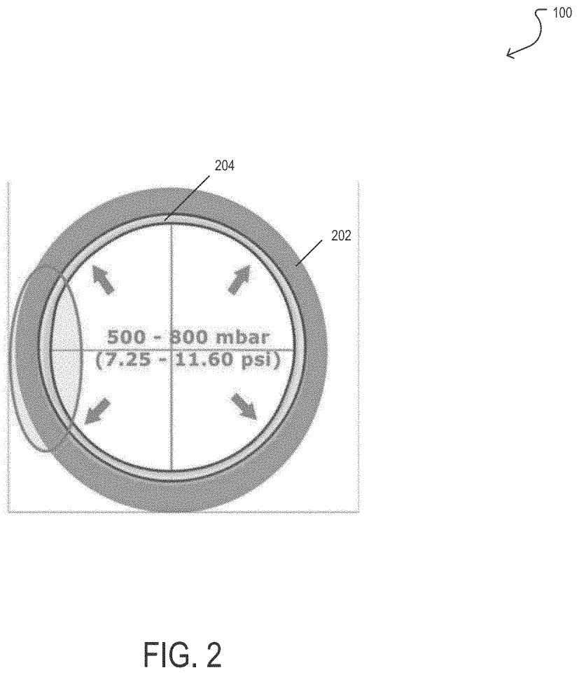

FIG. 2 shows a cross-section view of the pipe liner system 100 according to an example of the instant disclosure. As shown in FIG. 2, the fiberglass liner/resin combination may cure and form a solid piping system with the original or failing host pipe. After the resin has cured, an epoxy may be applied over or on the surface of the resin/fiberglass combination. The epoxy may be determined or matched based on the needs and designed to withstand hazardous materials that may be deposited into the piping system. As an example, the epoxy may be provided by BELZONA and may be an epoxy for oily sewer water or liquids (e.g., number 5811), an epoxy for a sewer that handles sulfuric acid (e.g., number 4311), and another type of epoxy that may handle very hot liquids (number 1523), e.g., up to 410 degrees Fahrenheit. The epoxy may withstand hazardous materials including hydrocarbons, benzene, hydrogen sulfide (H2S), acids, and other types of hazardous materials. FIG. 2 shows the original host pipe/carrier pipe 202. The fiberglass liner is shown as 204 that is inflated and inserted into position. As shown in FIG. 2, there may be typically 500-800 Millibars of air pressure or 7.25 to 11.60 pounds per square inch (psi).

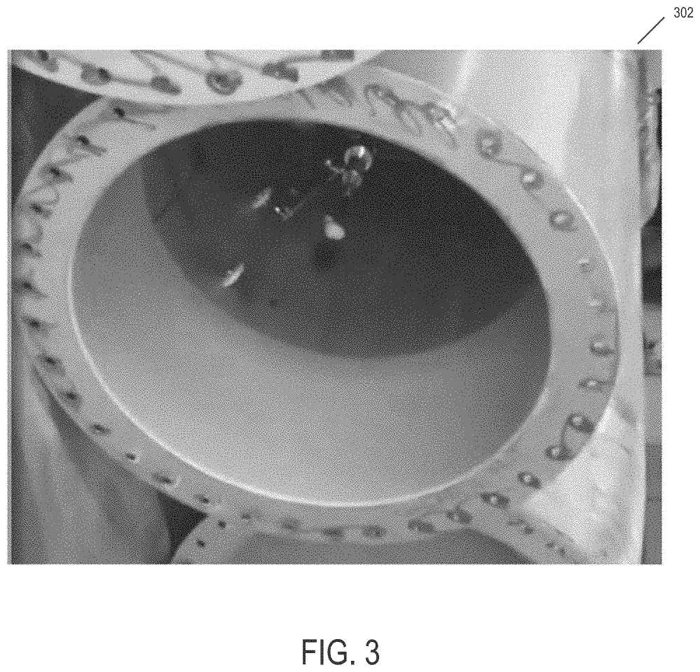

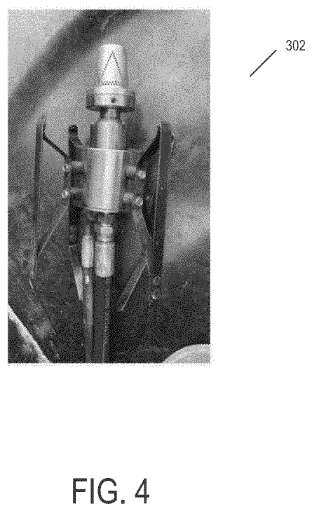

FIGS. 3 and 4 show different photographic views of a spin sprayer 302 that may apply one or more coats of epoxy in the pipe liner system 100 according to an example of the instant disclosure. Surface preparation serves as a major factor in having epoxy coatings adhere properly. It typically requires surface preparation by grinding or sand blasting. Such preparation is messy and costly to create a quality surface that may adhere to the epoxy coating. However, the chemical sewer pipe liner system 100 and associated installation can control the surface such that the epoxy may be sprayed directly to the liner such that it has a very consistent surface. In addition, the spin sprayer 302 may apply the coating at 4,000-7,000 psi and may atomize the epoxy to allow for a smooth consistent coating that optimizes the life and quality of the system 100.

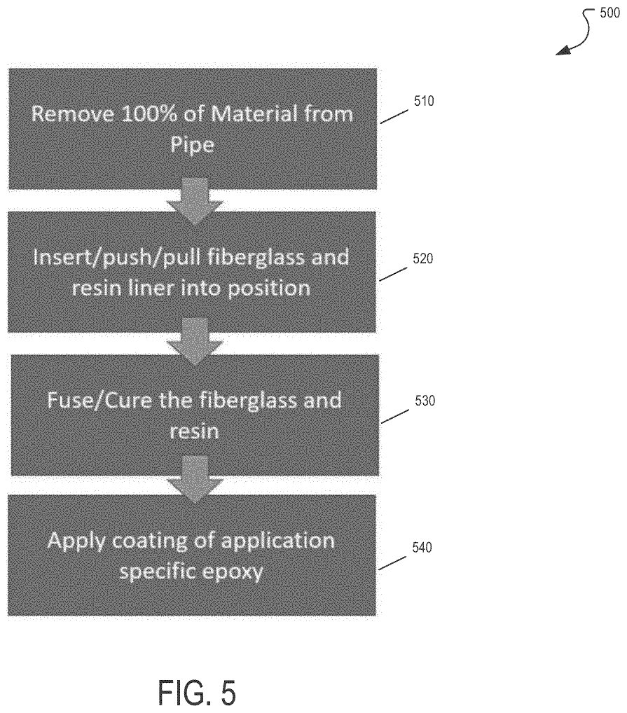

FIG. 5 illustrates an example method 500 for installing a chemical sewer pipe liner according to an example of the instant disclosure. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

According to some examples, the method 500 includes removing 100% or substantially all of the material or process waste from the pipe at block 510. In other words, the method 500 may include removing as much process waste as possible. The process waste may include gray sulfur, catalyst, residual from crude unit, condensate, and all combinations that may react in the sewer pipe when dumped into the sewer pipe. It also may include crude oil or diesel.

According to some examples, the method 500 includes inserting, pushing, and/or pulling the fiberglass and resin liner into position in the pipe at block 520. In other words, the fiberglass and resin liner may be adjusted and put in place to cover identified structural imperfections in the pipe.

According to some examples, the method 500 includes fusing and/or curing the fiberglass and resin at block 530. The fiberglass resin may be fused using ultraviolet (UV) spectrum light and/or an ambient air induced chemical reaction. As an example, a longer pipe run may utilize UV curing and a shorter pipe run may be fused or cured using the ambient air induced chemical reaction.

According to some examples, the method 500 includes applying at least one coating of application specific epoxy at block 540. As an example, the amount of coating that may be applied may be in a range from 0.20″ to 0.50″. In addition, the application specific epoxy may be capable of withstanding at least one of hydrocarbons, benzene, hydrogen sulfide (H2S), and acids.

According to some examples, the method 500 may further include inserting, pulling, and pushing the fiberglass and resin liner from above ground.

According to some examples, the method 500 may further include using ultraviolet (UV) spectrum light to at least one of fuse and cure the fiberglass and resin liner. As another example, the method 500 may further include using an ambient air induced chemical reaction to at least one of fuse and cure the fiberglass and resin liner.

According to some examples, the method 500 may further include adjusting the fiberglass and resin liner to cover identified structural imperfections in the pipe.

According to some examples, the method 500 may further include inflating the fiberglass and resin liner to take a shape of the pipe before the at least one of fusing and curing the fiberglass and resin liner in the pipe, wherein the fiberglass and resin liner is inflated to 7.25 to 11.60 pounds per square inch.

The system 100 discussed herein may be utilized in a variety of different fields and applications including petrochemical uses, oil and gas uses, and energy and refining, among others. As an example, chemical plants, refineries, paper mills, and metal producers may be able to utilize the system 100 discussed herein. These examples may utilize damaged and aging buried infrastructure that is not easily repaired. There are simply no current viable solutions in many instances. As an example, it may be $5 million to $10 million and many months of work to dig up a pipe. In addition, the plant may have many different segments of pipe that have to be individually addressed. The system discussed herein solves and addresses these problems in a fraction of the time, e.g., may be installed in days, and may be a small fraction of the financial cost.

The fiberglass, resin, and epoxy improves upon the conventional and existing approaches because they fail and do not last. Unfortunately, one of the conventional “solutions” includes choosing to not address a pipe failure and allowing the pipe to leak and pollute because there is not a viable way to address the issue. As a result, the system 100 provides major environmental benefits over the current “solutions” of often doing nothing.

The invention is not limited to the particular embodiments illustrated in the drawings and described above in detail. Those skilled in the art will recognize that other arrangements could be devised. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. While the invention has been described with reference to specific illustrative embodiments, modifications and variations of the invention may be constructed without departing from the spirit and scope of the invention as set forth in the following claims.

Illustrative examples of the disclosure include:

Aspect 1: A method comprising: removing process waste from a pipe, performing at least one of inserting, pulling, and pushing a fiberglass liner that is impregnated with resin into position within the pipe, at least one of fusing and curing the fiberglass and resin liner in the pipe, and applying at least one coating of an application specific epoxy over a surface of the fiberglass and resin liner in the pipe.

Aspect 2: The method of Aspect 1, further comprising inserting, pulling, and pushing the fiberglass and resin liner from above ground.

Aspect 3: The method of Aspects 1 and 2, wherein the at least one application specific epoxy has a thickness in a range from 0.20″ to 0.50″.

Aspect 4: The method of Aspects 1 to 3, further comprising using ultraviolet (UV) spectrum light to at least one of fuse and cure the fiberglass and resin liner.

Aspect 5: The method of Aspects 1 to 4, further comprising using an ambient air induced chemical reaction to at least one of fuse and cure the fiberglass and resin liner.

Aspect 6: The method of Aspects 1 to 5, wherein the application specific epoxy is capable of withstanding at least one of hydrocarbons, benzene, hydrogen sulfide (H2S), and acids.

Aspect 7: The method of Aspects 1 to 6, further comprising adjusting the fiberglass and resin liner to cover identified structural imperfections in the pipe.

Aspect 8: The method of Aspects 1 to 7, further comprising inflating the fiberglass and resin liner to take a shape of the pipe before the at least one of fusing and curing the fiberglass and resin liner in the pipe, wherein the fiberglass and resin liner is inflated to 7.25 to 11.60 pounds per square inch.

Aspect 9: A system comprising: a fiberglass liner that is impregnated with resin and at least one of inserted, pulled, and pushed into position in a pipe that has process waste removed, an inflating device that inflates the fiberglass liner that is impregnated with resin to take a shape of the pipe, wherein the fiberglass and resin liner is inflated to 7.25 to 11.60 pounds per square inch, and a spin sprayer that applies at least one coating of an application specific epoxy over a surface of the fiberglass and resin liner in the pipe.

Aspect 10: The system of Aspect 9, wherein the fiberglass liner is inserted, pulled, and pushed from above ground.

Aspect 11: The system of Aspects 9 and 10, wherein the at least one application specific epoxy has a thickness in a range from 0.20″ to 0.50″.

Aspect 12: The system of Aspects 9 to 11, wherein ultraviolet (UV) spectrum light is used to at least one of fuse and cure the fiberglass and resin liner.

Aspect 13: The system of Aspects 9 to 12, wherein an ambient air induced chemical reaction is used to at least one of fuse and cure the fiberglass and resin liner.

Aspect 14: The system of Aspects 9 to 13, wherein the application specific epoxy is capable of withstanding at least one of hydrocarbons, benzene, hydrogen sulfide (H2S), and acids.

Aspect 15: The system of Aspects 9 to 14, wherein the fiberglass and resin liner is adjusted to cover identified structural imperfections in the pipe.

Aspect 16: The system of Aspects 9 to 15, wherein the fiberglass and resin liner is inflated to take a shape of the pipe before the at least one of fusing and curing the fiberglass and resin liner in the pipe, wherein the fiberglass and resin liner is inflated to 7.25 to 11.60 pounds per square inch.

Aspect 17: A system for trenchless repair of damaged hazardous material sewers, comprising: a fiberglass liner that is impregnated with resin and at least one of inserted, pulled, and pushed into position in a pipe to address identified structural imperfections in the pipe buried in the earth that has process waste removed, an inflating device that inflates the fiberglass liner that is impregnated with resin to conform to a shape of the pipe, wherein the fiberglass and resin liner is inflated to 7.25 to 11.60 pounds per square inch, and a spin sprayer that applies at least one coating of an application specific epoxy having a thickness of 0.20″ to 0.50″ over a surface of the fiberglass and resin liner in the pipe, the application specific epoxy withstanding at least one of hydrocarbons, benzene, hydrogen sulfide (H2S), and acids.

Aspect 18: The system of Aspect 17, wherein the pipe is located at one of a plant operating unit, roadway, railway, and waterway.

Aspect 19: The system of Aspects 17 and 18, wherein the process waste comprises at least one of gray sulfur, catalyst, residual from crude unit, condensate, crude oil, and diesel fuel.

Aspect 20: The system of Aspects 17 to 19, wherein the fiberglass liner is fused with the resin using ultraviolet (UV) spectrum light when the pipe is longer than a particular length and using an ambient air induced chemical reaction when the pipe is equal to or less than the particular length.

What is claimed is:

1. A method comprising:
removing process waste from a pipe;
performing at least one of inserting, pulling, and pushing a fiberglass liner that is impregnated with resin into position within the pipe;
at least one of fusing and curing the fiberglass and resin liner in the pipe; and
applying at least one coating of an application specific epoxy over a surface of the fiberglass and resin liner in the pipe.

2. The method of claim 1, further comprising inserting, pulling, and pushing the fiberglass and resin liner from above ground.

3. The method of claim 1, wherein the at least one application specific epoxy has a thickness in a range from 0.20″ to 0.50″.

4. The method of claim 1, further comprising using ultraviolet (UV) spectrum light to at least one of fuse and cure the fiberglass and resin liner.

5. The method of claim 1, further comprising using an ambient air induced chemical reaction to at least one of fuse and cure the fiberglass and resin liner.

6. The method of claim 1, wherein the application specific epoxy is capable of withstanding at least one of hydrocarbons, benzene, hydrogen sulfide (H2S), and acids.

7. The method of claim 1, further comprising adjusting the fiberglass and resin liner to cover identified structural imperfections in the pipe.

8. The method of claim 1, further comprising inflating the fiberglass and resin liner to take a shape of the pipe before the at least one of fusing and curing the fiberglass and resin liner in the pipe, wherein the fiberglass and resin liner is inflated to 7.25 to 11.60 pounds per square inch.

9. A system, comprising:
a fiberglass liner that is impregnated with resin and at least one of inserted, pulled, and pushed into position in a pipe that has process waste removed;
an inflating device that inflates the fiberglass liner that is impregnated with resin to take a shape of the pipe, wherein the fiberglass and resin liner is inflated to 7.25 to 11.60 pounds per square inch; and
a spin sprayer that applies at least one coating of an application specific epoxy over a surface of the fiberglass and resin liner in the pipe.

10. The system of claim 9, wherein the fiberglass liner is inserted, pulled, and pushed from above ground.

11. The system of claim 9, wherein the at least one application specific epoxy has a thickness in a range from 0.20″ to 0.50″.

12. The system of claim 9, wherein ultraviolet (UV) spectrum light is used to at least one of fuse and cure the fiberglass and resin liner.

13. The system of claim 9, wherein an ambient air induced chemical reaction is used to at least one of fuse and cure the fiberglass and resin liner.

14. The system of claim 9, wherein the application specific epoxy is capable of withstanding at least one of hydrocarbons, benzene, hydrogen sulfide (H2S), and acids.

15. The system of claim 9, wherein the fiberglass and resin liner is adjusted to cover identified structural imperfections in the pipe.

16. The system of claim 9, wherein the fiberglass and resin liner is inflated to take a shape of the pipe before the at least one of fusing and curing the fiberglass and resin liner in the pipe, wherein the fiberglass and resin liner is inflated to 7.25 to 11.60 pounds per square inch.

17. A system for trenchless repair of damaged hazardous material sewers, comprising:
a fiberglass liner that is impregnated with resin and at least one of inserted, pulled, and pushed into position in a pipe to address identified structural imperfections in the pipe buried in the earth that has process waste removed;
an inflating device that inflates the fiberglass liner that is impregnated with resin to conform to a shape of the pipe, wherein the fiberglass and resin liner is inflated to 7.25 to 11.60 pounds per square inch; and
a spin sprayer that applies at least one coating of an application specific epoxy having a thickness of 0.20″ to 0.50″ over a surface of the fiberglass and resin liner in the pipe, the application specific epoxy withstanding at least one of hydrocarbons, benzene, hydrogen sulfide (H2S), and acids.

18. The system of claim 17, wherein the pipe is located at one of a plant operating unit, roadway, railway, and waterway.

19. The system of claim 17, wherein the process waste comprises at least one of gray sulfur, catalyst, residual from crude unit, condensate, crude oil, and diesel fuel.

20. The system of claim 17, wherein the fiberglass liner is fused with the resin using ultraviolet (UV) spectrum light when the pipe is longer than a particular length and using an ambient air induced chemical reaction when the pipe is equal to or less than the particular length.
